(19) United States
(12) Patent Application Publication
(10) Pub. No.: US 2017/0140401 A1
(43) Pub. Date: May 18, 2017

(54) PREDICTION SYSTEM AND PREDICTION METHOD

(71) Applicant: NEC Corporation, Tokyo (JP)

(72) Inventors: Yusuke MURAOKA, Tokyo (JP); Ryohei FUJIMAKI, Tokyo (JP)

(21) Appl. No.: 15/323,280

(22) PCT Filed: Jun. 4, 2015
(86) PCT No.: PCT/JP2015/002823

§ 371 Date: Dec. 30, 2016

Related U.S. Application Data
(60) Provisional application No. 62/018,880, filed on Jun. 30, 2014.

(51) Int. Cl. G06Q 30/02; G06N 7/00

(52) U.S. Cl. CPC G06Q 30/0202; G06N 7/005

(57) ABSTRACT

From learning data that expresses inter-node connection relationships that are expressed as a graph structure or a network structure, a vicinal node information acquisition unit 81 acquires edge information that indicates the connection relationship between one node and another node to which the one node connects. Using the acquired edge information and node feature information that indicates the features of the other node, a feature value calculation unit 82 calculates a feature value that is for the one node and that is to be used for prediction.

### TECHNICAL FIELD

The present invention relates to a prediction system, a prediction method, and a prediction program for predicting the characteristics of a target node.

### BACKGROUND ART

Data mining is a technique of finding useful knowledge that has been unknown out of a large amount of information. The use of a result of knowledge obtained by data mining enables discovering customers' hidden desires or predicting the behavior or characteristics of a target to take appropriate measures.

For a customer who wants to receive a service, it is possible to provide a service matching the customer's needs appropriately by predicting behavior characteristics on the basis of personal information of the customer. Moreover, this prediction enables early grasping of points with which the customer is not satisfied, and therefore appropriate measures can be taken.

Patent Literature (PTL) 1 describes a content distribution apparatus which distributes contents such as an advertisement via the Internet or other networks. The content distribution apparatus described in PTL 1 extracts information on users who performed a target behavior of a campaign from log data and calculates feature values of the users. Then, users likely to perform the target behavior of the campaign are extracted on the basis of scores by users calculated based on the feature values.

### CITATION LIST

### Patent Literature

PTL 1: Japanese Patent Application Laid-Open No. 2014-2683

### SUMMARY OF INVENTION

### Technical Problem

Generally, when predicting the characteristics of an object, the feature of the object or the observation data of the object is used. For example, when predicting user's behavior characteristics, the user's sex or age or the past purchase history or call time of the user is used as an explanatory variable.

In the case where the features or the like of the object used as explanatory variables are insufficient such as a case where a user who wants to receive a service forgets to input his/her personal information or the like, the situation leads to a technical problem such as decreasing the accuracy for predicting the behavior characteristics of the object.

Moreover, the content distribution apparatus described in PTL 1 is also not able to calculate a feature value appropriately in the case where the extracted information on a user is insufficient. Therefore, the accuracy of scores by users calculated based on such feature values is also decreased, by which users targeted for the campaign cannot be extracted appropriately, thus providing a technical problem.

Therefore, it is an object of the present invention to provide a prediction system, a prediction method, and a prediction program capable of generating information for calculating a new feature value for estimating the feature of a target even in the case where information on a prediction target is insufficient.

### Solution to Problem

According to the present invention, there is provided a prediction system including: a vicinal node information acquisition unit that acquires edge information that indicates the connection relationship between one node and another node to which the one node connects, from learning data that expresses inter-node connection relationships that are expressed as a graph structure or a network structure; and a feature value calculation unit that calculates a feature value that is for the one node and that is to be used for prediction by using the acquired edge information and node feature information that indicates the features of the other node.

According to the present invention, there is provided a prediction method wherein: a vicinal node information acquisition unit acquires edge information that indicates a connection relationship between one node and another node to which the one node connects, from learning data that expresses inter-node connection relationships that are expressed as a graph structure or a network structure; and a feature value calculation unit calculates a feature value that is for the one node and that is to be used for prediction by using the acquired edge information and node feature information that indicates the features of the other node.

According to the present invention, there is provided a prediction program for causing a computer to perform: vicinal node information acquisition processing of acquiring edge information that indicates a connection relationship between one node and another node to which the one node connects, from learning data that expresses inter-node connection relationships that are expressed as a graph structure or a network structure; and feature value calculation processing of calculating a feature value that is for the one node and that is to be used for prediction by using the acquired edge information and node feature information that indicates the features of the other node.

### Advantageous Effects of Invention

According to the present invention, the aforementioned technical means provide a technical advantageous effect such that information for calculating a new feature value for estimating the feature of a target can be generated with high accuracy even in the case where information on a prediction target is insufficient.

### BRIEF DESCRIPTION OF DRAWINGS

FIG. 1 is a block diagram illustrating an exemplary embodiment of a prediction system according to the present invention.

FIG. 2 is an explanatory diagram illustrating a sample of leaning data.

FIG. 3 is a flowchart illustrating a sample of an operation until a prediction model is generated.

FIG. 4 is a flowchart illustrating a sample of an operation of performing a prediction by using a prediction model.

FIG. 5 is a block diagram illustrating an outline of the prediction system according to the present invention.

FIG. 6 is a block diagram illustrating the outline of the configuration of a computer.

### DESCRIPTION OF EMBODIMENT

Hereinafter, an exemplary embodiment of the present invention will be described with reference to drawings.

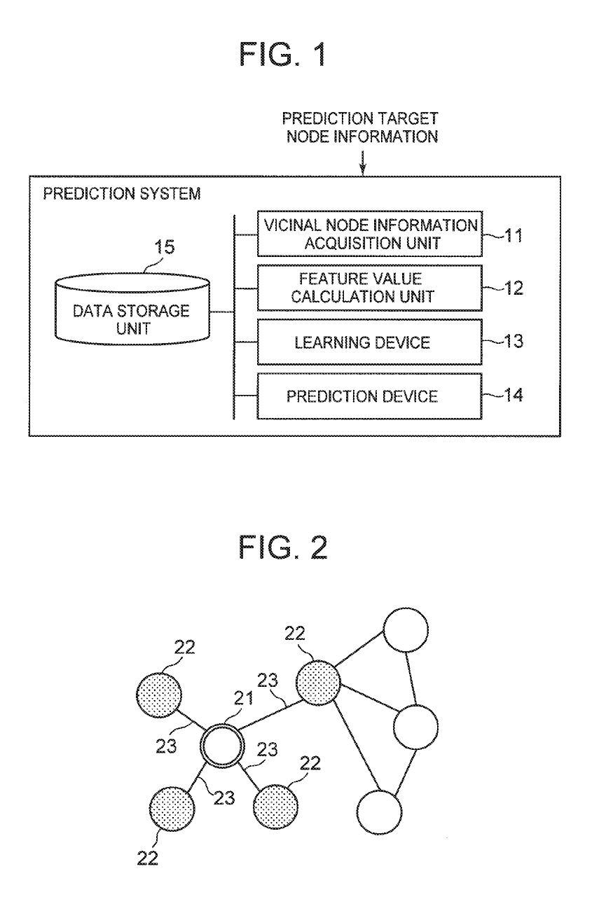

FIG. 1 is a block diagram illustrating an exemplary embodiment of a prediction system according to the present invention. The prediction system according to the present exemplary embodiment includes a vicinal node information acquisition unit 11, a feature value calculation unit 12, a learning device 13, a prediction device 14, and a data storage unit 15.

The data storage unit 15 stores learning data used for learning by the learning device 13. The data storage unit 15 according to the present exemplary embodiment includes information on a learning target group and an information group that expresses a link between the learning targets as leaning data. These connection relationships can be expressed as a graph structure or a network structure, where the learning target is associated with a node and the link between the learning targets is associated with an edge.

Therefore, in the following description, a learning target or a prediction target is referred to as a node and a link between learning targets or between prediction targets is referred to as an edge. Specifically, the learning data used in the present exemplary embodiment includes node feature information that expresses the characteristics of each node and edge information that expresses inter-node connection relationships that are expressed as a graph structure or a network structure. Specifically, it can be said that feature information is correlated with each node.

FIG. 2 is an explanatory diagram illustrating a sample of leaning data. For example, when focusing on a node 21 illustrated in FIG. 2, the data storage unit 15 stores information on the node 21 itself that is a learning target and information on an edge 23 that connects the node 21 and a node 22 to each other as learning data.

The following describes the node feature information that expresses the characteristics of a node by giving a specific example. For example, a situation in which an individual is using a communication system service is simulated. In this case, each node corresponds to a customer who uses the service. In this situation, the node feature information that expresses the characteristics of the node includes information on an individual contracting the service such as, for example, the sex or age. In addition, the node feature information may include other information such as information indicating how the individual is using the service (for example, a chat frequency per day, call time, or the like).

Furthermore, the node feature information is not limited to the information that expresses the features of the individual him/herself and may include information indicating the usage of a communication device used by the individual, the operating system (OS) installed in the communication device, application software for performing communication processing, or the like. Furthermore, the node feature information may include advertisement information or campaign, information indicating the sensitivity to coupons, or the like. In this case, it can be said that the node corresponds to a communication device or a user thereof.

Subsequently, edge information that expresses the inter-node connection relationship will be described by giving a specific example. For example, if a learning/prediction target is an amount related to a user who uses a social networking service (hereinafter, referred to as SNS) or a chat, communication data (transaction data) including a sender ID or a receiver ID of an access source and a date or a type (for example, roaming/data communication) can be taken as a sample of edge information. In this case, a user who uses a service corresponds to a node, and communication data indicating a connection history (connection relationship) between users corresponds to edge information. An edge connecting one node to another node indicates that a user corresponding to one node has performed communication with a user corresponding to another node via a communication device in the past, for example. Edge information may include other information such as information about a communication frequency, the number of communication times, and a communication direction.

Additionally, if a learning/prediction target is a user who uses a telephone, for example, a call detail record (CDR), which is a detailed record of calls, can be taken for instance of edge information. The CDR includes information for identifying a caller, a receiver, a date, a call type (call/SMS [short message service]/MMS [multimedia messaging service]), call time, and the like. Since the CDR includes information for identifying a caller and a receiver as described above, a telephone service contractor corresponds to a node and the CDR corresponds to edge information. For example, an opposite party with which communication has been performed via a call, an SMS, or an MMS can be extracted as a friend by using the CDR.

The content of edge information is not limited to the aforementioned communication data or to the CDR and only needs to be data that is able to express inter-node connection relationships that are expressed as a graph structure or a network structure. Moreover, the edge information may be included in a part of the feature information or may be managed as information different from the feature information. If the edge information is included as a part of feature information, the information corresponding to the graph structure or the network structure illustrated in FIG. 2, for example, may be correlated with the node 11 as feature information. For example, the identification information of a node that is an opposite party with which communication has been performed in the past in a communication record may be correlated with the node as feature information. Moreover, information about the communication frequency or the number of communication times in communications with an opposite party may be correlated with the node as feature information.

The vicinal node information acquisition unit 11 acquires edge information that indicates the connection relationship between one node and another node to which the one node connects from leaning data stored in the data storage unit 15. The vicinal node information acquisition unit 11 then determines a node close to the one node on the basis of the acquired edge information and acquires the feature information of the determined node from the leaning data.

The vicinal node includes not only a node adjacent to the one node (specifically, a node having a direct connection relationship with the one node), but also a node located at a predetermined distance from the one node.

The feature value calculation unit 12 calculates a feature value that is for a node and that is to be used for prediction by using the acquired edge information and node feature information. The feature value calculated here is used as an explanatory variable used for prediction by a learning device 13 described later.

The content of the feature value calculated by the feature value calculation unit 12 is arbitrary as long as the feature value is generated by using at least the node feature information and the edge information of the vicinal node. For example, if the learning/prediction target is a person, the feature value calculation unit 12 may calculate the proportion of sex or the average of age of a person expressed by a vicinal node as a feature value of the learning/prediction target or may calculate the statistic calculated on the basis of feature information correlated with an opposite party with which the learning/prediction target has performed communication in the past as a feature value of the learning/prediction target.

Moreover, if the edge information includes information on the communication frequency between nodes connected to each other, the feature value calculation unit 12 may calculate the feature information correlated with the vicinal node close to the learning/prediction target node and information generated on the basis of the above communication frequency as feature values of the learning/prediction target node.

Moreover, the feature value calculation unit 12 may calculate the statistic on the feature value of friends as a feature value of one's own. Specifically, one node corresponds to oneself and vicinal nodes corresponds to friends. In this situation, the feature value calculation unit 12 may calculate the proportion of men in friends, the average of communication charge of friends, or the proportion of contract cancellers in friends, for example, as a feature value.

In addition, the feature value calculation unit 12 may calculate the feature value by using information indicating a time variation of the node feature information of the vicinal node acquired by the vicinal node information acquisition unit 11. As the information indicating the time variation of the node feature information, there can be taken information that the opposite user who uses the same service has cancelled the service or information that the content of the contract has been changed. The use of this type of information enables the prediction of the characteristics of a prediction target node depending on a change in the node (vicinal node) related to the prediction target node.

Moreover, the feature values calculated by the feature value calculation unit 12 are not limited to one type, but two or more types of feature values may be employed. The feature value calculation unit 12 may calculate M types of feature values and the feature values may be expressed by an M-dimensional multivariate data sequence (xⁿ=x₁ⁿ, - - - , x_{M}ⁿ).

The node feature information of a vicinal node itself may be insufficient among vicinal nodes in some cases. In the present exemplary embodiment, however, the feature value calculation unit 12 calculates the feature value on the basis of the node feature information of a plurality of vicinal nodes connected to one node. Therefore, even if the information of some vicinal nodes is insufficient, information of other vicinal nodes is able to make up for the lack of the information for calculating the feature values, thus enabling an increase in the accuracy of the calculated feature value of the node.

Although the feature value of the learning/prediction target node is calculated from the node feature information of the vicinal node in the description of the present exemplary embodiment, this shall not preclude a feature value calculated from the node feature information of the learning/prediction target node itself. The feature value calculation unit 12 may calculate the feature value from the node feature information of the learning/prediction target node itself.

The learning device 13 learns a model indicating the characteristics (behavior characteristics) of a node with the calculated feature value of the node as an explanatory variable. Specifically, with the characteristics of one node as an object variable and the feature value calculated by the feature value calculation unit 12 as an explanatory variable, the learning device 13 learns a model indicating the behavior of the node. In other words, it can be said that the information generated based on the node feature information of the vicinal node is used as an explanatory variable for predicting the characteristics of the learning/prediction target node on which attention is focused.

The learning device 13 may use a part of the feature value calculated by the feature value calculation unit 12 as an explanatory variable and may use the entire feature value as an explanatory variable. In this case, the learning device 13 can select the explanatory variable out of a plurality of feature values by using an arbitrary method. Specifically the learning device 13 is able to use the feature value calculated by the feature value calculation unit 12 for learning, in addition to the node feature information of the learning target node.

For example, if a communications company predicts the behavior characteristics of a customer, the presence or absence of a change in contract contents, the prediction of a communication charge or a call charge, a reaction to a campaign, or the like is used as an object variable for instance of the characteristics of the node. For example, in the case of learning a model of a communication charge or a call charge, the learning device 13 uses the communication charge or the call charge as an object variable and uses the feature value calculated by the feature value calculation unit 12 as an explanatory variable.

In addition, for example, in the case of learning a model of cancellation of a telephone service, the learning device 13 uses the information that expresses the cancellation of the telephone service contractor as an object variable and uses the feature value calculated by the feature value calculation unit 12 as an explanatory variable with respect to the telephone service contractor. The model of cancellation is not limited to the cancellation of a telephone service and can be applied to a situation of cancelling a service provided by SNS, a situation of cancelling a reservation, a situation of performing a model change of a telephone set, or the like.

The method in which the learning device 13 learns a model is arbitrary and there are various methods such as a regression analysis, a discrimination analysis, and the like. The learning device 13 may select an appropriate leaning method according to the object variable. For example, such a case is assumed that the learning device 13 performs a multiple regression analysis with the characteristics of a node desired to be predicted as an object variable. In this case, the learning device 13 is likely to output, as a result of learning, a model (regression equation) that includes the feature value calculated by the feature value calculation unit 12 as an explanatory variable.

In this manner, the learning device 13 of this exemplary embodiment uses the feature value calculated from the node feature information of a vicinal node as an explanatory variable. Therefore, even in the case where the node feature information of a prediction target node itself cannot be acquired, the learning device 13 is able to learn the prediction model of the behavior characteristics of the node with high accuracy.

The prediction device 14 predicts the characteristics of the node. Specifically, first, upon an input of the prediction target node, the vicinal node information acquisition unit 11 acquires the edge information of the prediction target node and the node feature information of a vicinal node close to the target node, and the feature value calculation unit 12 calculates the feature value of the prediction target node by using the acquired edge information and node feature information. The prediction device 14 predicts the characteristics of the prediction target node by using the model learned by the learning device 13 and the feature value of the prediction target node.

Specifically, the prediction device 14 of this exemplary embodiment predicts the characteristics of the prediction target node by using the feature value generated from the node feature information of the vicinal node. Therefore, even in the case of insufficient node feature information of the prediction target node itself, the prediction device 14 is able to predict the characteristics of the prediction target node appropriately.

For example, if a person simply forgets to input his/her personal information while clearly expressing his/her wish to receive a service using personal information, it is difficult to perform an appropriate prediction for the person in a general method, and therefore it has been impossible to provide appropriate advertisement or campaign information on a timely basis in some cases. In the present exemplary embodiment, however, the feature value calculated from the information of the vicinal node is used as an explanatory variable, and therefore a person who forgets to input his/her personal information can be provided with the service appropriately.

Moreover, for example, with respect to a person who uses a prepaid mobile phone though the person clearly expresses his/her wish to receive the service using personal information, it is difficult to acquire sufficient personal information. Therefore, it has been difficult to perform appropriate prediction for the person in a general method.

A call destination of a prepaid mobile phone often uses a postpaid phone and the information on the call destination can be acquired from the CDR. The feature value of a person who uses a prepaid mobile phone can be calculated on the basis of the information on the call destination as described above. Therefore, even in the case where it is difficult to acquire sufficient personal information, the characteristics of an object person can be appropriately predicted.

The vicinal node information acquisition unit 11, the feature value calculation unit 12, the learning device 13, and the prediction device 14 are implemented by the CPU of a computer operating according to a program (a prediction program). For example, the program is stored in a storage unit (not illustrated) in the prediction system, and the CPU may read the program so as to operate as the vicinal node information acquisition unit 11, the feature value calculation unit 12, the learning device 13, and the prediction device 14 according to the program.

Furthermore, the vicinal node information acquisition unit 11, the feature value calculation unit 12, the learning device 13, and the prediction device 14 may be each implemented by dedicated hardware. Moreover, the data storage unit 15 is implemented by a magnetic disk unit or the like, for example.

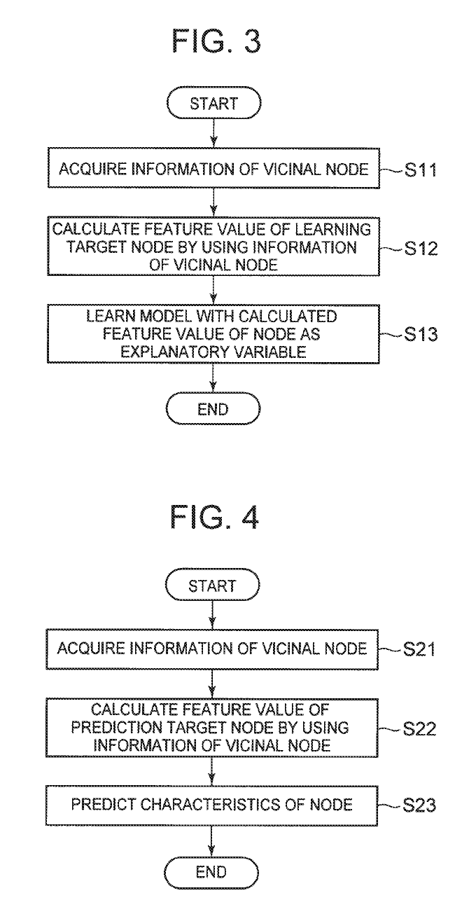

Subsequently, the operation of a prediction system according to the present exemplary embodiment will be described. FIG. 3 is a flowchart illustrating a sample of an operation until the prediction system according to the first exemplary embodiment generates a prediction model. Additionally, it is assumed that the data storage unit 15 stores learning data including edge information and node feature information that expresses inter-node connection relationships that are expressed as a graph structure or a network structure.

The vicinal node information acquisition unit 11 acquires the edge information of a learning target node and the node feature information of a vicinal node (vicinal node information) (step S11). The feature value calculation unit 12 calculates the feature value of the learning target node used for prediction by using the acquired edge information and node feature information (step S12). The feature value enabling an improvement of the prediction accuracy can be calculated by performing the processing up to here.

Subsequently, the learning device 13 learns a model indicating the behavior characteristics of the node by using the characteristics of the learning target node as an object variable and the calculated feature value of the node as an explanatory variable (step S13). The learning of the model based on the feature value calculated in step S12 enables a generation of a model capable of improving the prediction accuracy.

Subsequently, processing of predicting the characteristics of a prediction target node is performed by using the generated model. FIG. 4 is a flowchart illustrating a sample of an operation of performing a prediction by using a prediction model generated by the prediction system according to the exemplary embodiment.

First, the vicinal node information acquisition unit 11 acquires the edge information of the prediction target node and the node feature information of a vicinal node (vicinal node information) (step S21). Then, the feature value calculation unit 12 calculates the feature value of the prediction target node by using the edge information and the node feature information (step S22). Thereafter, the prediction device 14 predicts the characteristics of the prediction target node by using the model learned by the learning device 13 and the feature value of the prediction target node (step S23).

For example, in the case of predicting the characteristics of a call service contractor, the vicinal node information acquisition unit 11 determines a call destination from a call log (CDR) indicating the inter-node connection relationship where a telephone service contractor is a node and separately acquires information about the determined call destination (for example, the feature information of the node of the call destination, a terminal in use, a taste, and the like). The feature value calculation unit 12 calculates the feature value of the call service contractor by using the information on the vicinal node (for example, a proportion of features of the call destination, a call time for each feature of the call destination, etc.).

As described above, in the present exemplary embodiment, the vicinal node information acquisition unit 11 acquires edge information indicating a connection relationship between one node and another node to which the one node connects from the learning data that expresses inter-node connection relationships that are expressed as a graph structure or a network structure, and the feature value calculation unit 12 calculates a feature value that is for the one node and that is to be used for prediction by using the acquired edge information and node feature information indicating the features of other nodes. Therefore, even in the case of insufficient information about a prediction target, it is possible to generate a feature value (explanatory variable) for predicting the characteristics of the target.

### Example 1

Hereinafter, the present invention will be described with reference to a specific example, but the scope of the present invention is not limited to the contents described below. In the present example, in the case of an individual contracting a chat system service, the probability that the individual cancels the chat system service in the future is predicted.

In a general method, an explanatory variable that expresses the service usage of the individual is used for the prediction. In this case, for example, a chat call frequency per day of a prediction target individual or the like is employed as an explanatory variable and learning and prediction have been performed on the basis of the explanatory variable.

In the present example, instead of the aforementioned explanatory variable or in addition to the aforementioned variable, a chat call frequency per day of the opposite party which is performing communication with the prediction target individual is used as a candidate for the explanatory variable. Specifically, the chat call frequency per day of the opposite party corresponds to the node feature information of the vicinal node in the above exemplary embodiment.

The probability of cancelling the chat system service is predicted by using a prediction expression based on the following two types of explanatory variables (explanatory variable A, explanatory variable B):

Explanatory variable A: Variation in a chat call frequency per day of an individual
Explanatory variable B: Variation in chat call frequency statistics (a total value, an average value, or the like) per day of a communication opposite party (one or a plurality of persons)

Here, it is supposed that the explanatory variable A indicates a content that the variation in the chat call frequency per day of the prediction target individual is increasing slightly and that the explanatory variable B indicates a content that the variation in the chat call frequency statistics (a total value, an average value, or the like) per day of the opposite party (one or a plurality of persons) who is performing communication with the prediction target individual is remarkably decreasing.

In a general prediction method, the explanatory variable B is not taken into consideration and therefore seemingly it is though that the individual will not cancel the contract of the chat system service if only the explanatory variable A is considered. Considering the explanatory variable B, however, it is understood that the situation is at rather high risk that the individual will cancel the contract of the chat system service. It is because that, if the opposite party with which a user corresponding to the node, on which attention is focused, has frequently performed communication begins to decrease the use of the chat system service, it is thought that the user will also decrease the use of the chat system service in the future.

In this manner, if it is required to predict future trends with respect to one node, the trends can be grasped or predicted more accurately in some cases with respect to a prediction target node by reference to not only the feature information of the prediction target itself, but also feature information of other nodes (in other words, vicinal nodes) that have ever performed communication with the prediction target.

### Example 2

Although the first example has illustrated a sample of a method of predicting a trend of a prediction target, the prediction processing according to the first example is applicable to a situation of providing an object person with appropriate information. In the present example, a system for sending (pushing) an advertisement occasionally to a user who uses a free chat system service is assumed.

A system using a general prediction method does not hold information that expresses what kind of advertisement a target individual likes in many cases even in the case where the system is to send an advertisement appropriate for a user who uses a free service. Therefore, it is difficult to say that the system is able to provide the user with appropriate advertisement in an effective manner.

In the chat system, however, it can be assumed that individuals having a similar taste perform communication frequently with each other. The prediction system according to the above exemplary embodiment is able to predict an advertisement that the target individual likes, on the basis of information that expresses what kind of advertisement the opposite party performing communication with the target individual likes. Therefore, the prediction system according to the above exemplary embodiment is able to provide a user with appropriate advertisement in an effective manner.

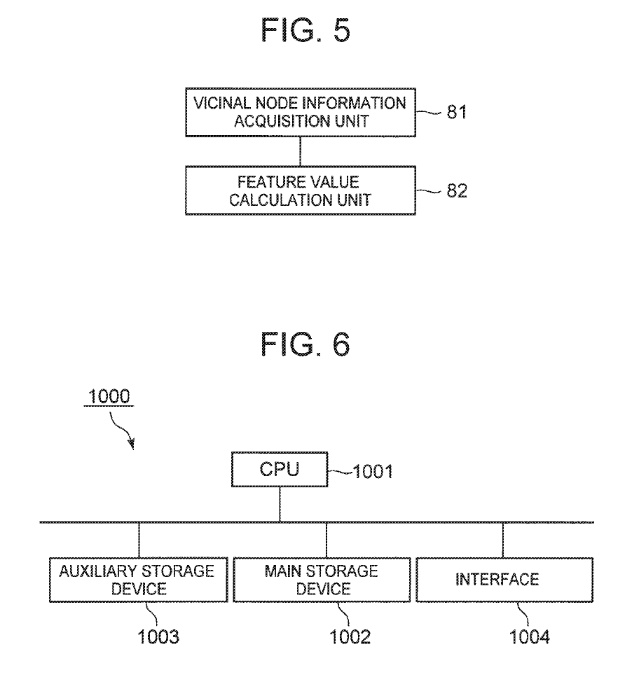

Subsequently, the outline of the present invention will be described. FIG. 5 is a block diagram illustrating an outline of the prediction system according to the present invention. The prediction system according to the present invention includes: a vicinal node information acquisition unit 81 (for example, the vicinal node information acquisition unit 11) that acquires edge information that indicates the connection relationship between one node (for example, a learning target node) and another node to which the one node connects, from learning data (for example, the learning data illustrated in FIG. 2) that expresses inter-node connection relationships that are expressed as a graph structure or a network structure; and a feature value calculation unit 82 (for example, the feature value calculation unit 12) that calculates a feature value that is for the one node and that is to be used for prediction by using the acquired edge information and node feature information that indicates the features of other nodes.

With this configuration, even in the case of insufficient information on the prediction target, it is possible to generate information for use in calculating a new feature value used to estimate the feature of a target with high accuracy.

Moreover, the prediction system may include a learning device (for example, the learning device 13) for learning a model indicating the characteristics of a node by using the characteristics of one node as an object variable and the calculated feature value of the one node as an explanatory variable.

Furthermore, the prediction system may include a prediction device (for example, the prediction device 14) for predicting the characteristics of a node. Additionally, the vicinal node information acquisition unit 81 may acquire the edge information of a prediction target node, the feature value calculation unit 82 may calculate the feature value of the prediction target node by using the edge information and the node feature information of other nodes, and the prediction device may predict the characteristics of the prediction target node by using the model learned by the learning device and the feature value of the prediction target node.

Moreover, the vicinal node information acquisition unit 81 may acquire the node feature information of other nodes from the edge information. Specifically, the vicinal node information acquisition unit 81 may acquire information indicating the time variations of other nodes as the node feature information.

FIG. 6 is a block diagram illustrating the outline of the configuration of a computer. A computer 1000 includes a CPU 1001, a main storage device 1002, an auxiliary storage device 1003, and an interface 1004.

The aforementioned prediction system is installed in one or more computers 1000. The prediction system according to the present invention may be composed of one device or may be composed of two or more devices that are physically separated from each other and connected by wired or wireless communication.

The operations of the respective processing units described above are stored in the auxiliary storage device 1003 in a program (prediction program) format. The CPU 1001 reads out the program from the auxiliary storage device 1003, develops the program to the main storage device 1002, and performs the above processing according to the program.

In at least one exemplary embodiment, the auxiliary storage device 1003 is a sample of a non-temporary tangible medium. Other samples of the non-temporary tangible medium include a magnetic disk, a magneto-optical disk, a compact disc read-only memory (CD-ROM), a digital versatile disk read-only memory (DVD-ROM), a semiconductor memory, and the like connected via the interface 1004. In the case where the program is delivered to the computer 1000 via a communication circuit, the computer that has received the delivery may develop the program to the main storage device 1002 and perform the above processing.

Moreover, the aforementioned program may be for use in implementing some of the aforementioned functions. Furthermore, the program may be a program for use in implementing the aforementioned functions by a combination with any other programs already stored in the auxiliary storage device 1003, that is, so-called a differential file (a differential program).

A part or all of the above exemplary embodiment can be described as in the following supplementary notes, but is not limited to the following description.

### Supplementary Note 1

A prediction system for predicting characteristics of a node, on which attention is focused, among a plurality of nodes constituting a graph structure or a network structure, the prediction system using information generated based on feature information correlated with the node adjacent to or close to the node, on which attention is focused, as an explanatory variable for predicting the characteristics of the node on which attention is focused.

### Supplementary Note 2

The prediction system according to Supplementary note 1, wherein: the graph structure or the network structure includes a plurality of nodes and edges each connecting the nodes to each other; the node corresponds to a communication device or to a user of the communication device; the feature information is information correlated with the node and is information communicating to the communication device or the user corresponding to the node or information indicating the usage of the communication device of the user corresponding to the node; and the edge corresponds to information indicating that the nodes connected to each other via the edge have ever performed communication in the past via the communication device.

### Supplementary Note 3

The prediction system according to Supplementary note 2, wherein: the user corresponding to the node, on which attention is focused, uses the statistic generated based on the feature information correlated with the opposite party with which the user has performed communication in the past, as an explanatory variable for predicting the characteristics of the node on which attention is focused.

### Supplementary Note 4

The prediction system according to Supplementary note 2, wherein: the edge includes information about a communication frequency between the nodes connected to each other via the edge and the feature information correlated with the node adjacent to or close to the node, on which attention is focused, and information generated based on the communication frequency are used as an explanatory variable for predicting the characteristics of the node on which attention is focused.

### Supplementary Note 5

A prediction system for predicting the characteristics of a user, on which attention is focused, among a plurality of users communicating to each other, the prediction system including: means for accepting an input of feature information associated with the user and an input of communication history information indicating a communication history between the users; means for determining a user who is a communication opposite party of the user, on which attention is focused, on the basis of the communication history information; and means for generating a model for predicting the characteristics of the user, on which attention is focused, by using the feature information associated with the determined user.

### Supplementary Note 6

A prediction system for predicting the characteristics of a communication device, on which attention is focused, among a plurality of communication devices communicating to each other, the prediction system including: means for accepting an input of feature information associated with the communication device and an input of communication history information indicating a communication history between the communication devices; means for determining a communication device which is a communication opposite party of the communication device, on which attention is focused, on the basis of the communication history information; and means for generating a model for predicting the characteristics of the communication device, on which attention is focused, by using the feature information associated with the determined communication device.

Although the present invention has been described with reference to the exemplary embodiment and examples hereinabove, the present invention is not limited thereto. A variety of changes, which can be understood by those skilled in the art, may be made in the configuration and details of the present invention within the scope thereof.

This application claims priority to U.S. provisional application No. 62/018,880 filed on Jun. 30, 2014, and the entire disclosure thereof is hereby incorporated herein by reference.

### REFERENCE SIGNS LIST

11 Vicinal node information acquisition unit
12 Feature value calculation unit
13 Learning device
14 Prediction device
15 Data storage unit
21, 22 Node
23 Edge

1.-11. (canceled)

12. A prediction system for predicting characteristics of a user, on which attention is focused, among a plurality of users communicating to each other, the prediction system comprising:
hardware including a processor;
an unit implemented at least by the hardware and for accepting an input of feature information associated with the users and an input of communication history information indicating a communication history between the users;
an unit implemented at least by the hardware and for identifying users who are a communication opposite party of a user based on the communication history information;
an unit implemented at least by the hardware and for generating a feature on the basis of a feature information associated with the identified users; and
an unit implemented at least by the hardware and for generating a model for predicting the characteristics of the user, on which attention is focused, by using the generated feature.

13. The prediction system according to claim 12, further comprising:
a vicinal node information acquisition unit implemented at least by the hardware and that acquires edge information that indicates a connection relationship between one user and another user to which the one user is communicating, from learning data that expresses inter-user connection relationships that are expressed as a graph structure or a network structure; and
a feature value calculation unit implemented at least by the hardware and that calculates a feature value that is for the one user and that is to be used for prediction by using the acquired edge information and feature information that indicates the features of the other user.

14. The prediction system according to claim 13, further comprising a learning device which learns a model indicating the characteristics of a user by using the characteristics of one user as an object variable and the calculated feature value of the one user as an explanatory variable.

15. The prediction system according to claim 12, further comprising a prediction device which predicts the characteristics of a user, wherein:
the vicinal node information acquisition unit acquires edge information of a prediction target user;
the feature value calculation unit calculates a feature value of the prediction target user by using the edge information and feature information of the other user; and
the prediction device predicts the characteristics of the prediction target user by using the model learned by the learning device and the feature value of the prediction target user.

16. The prediction system according to claim 12, wherein the vicinal node information acquisition unit acquires feature information of the other user from the edge information.

17. The prediction system according to claim 16, wherein the vicinal node information acquisition unit acquires information indicating time variation of the other user as feature information.

18. A prediction system for predicting characteristics of a communication device, on which attention is focused, among a plurality of communication devices communicating to each other, the prediction system comprising:
hardware including a processor;
an unit implemented at least by the hardware and for accepting an input of feature information associated with the communication devices and an input of communication history information indicating a communication history between the communication devices;
an unit implemented at least by the hardware and for identifying communication devices which are a communication opposite party of a communication device based on the communication history information;
an unit implemented at least by the hardware and for generating a feature on the basis of a feature information associated with the identified communication devices; and
an unit implemented at least by the hardware and for generating a model for predicting the characteristics of the communication device, on which attention is focused, by using the generated feature.

19. The prediction system according to claim 18, further comprising:
a vicinal node information acquisition unit implemented at least by the hardware and that acquires edge information that indicates a connection relationship between one communication device and another communication device to which the one communication device connects, from learning data that expresses inter-communication-device connection relationships that are expressed as a graph structure or a network structure; and
a feature value calculation unit implemented at least by the hardware and that calculates a feature value that is for the one communication device and that is to be used for prediction by using the acquired edge information and feature information that indicates the features of the other communication device.

20. The prediction system according to claim 19, further comprising a learning device which learns a model indicating the characteristics of a communication device by using the characteristics of one communication device as an object variable and the calculated feature value of the one communication device as an explanatory variable.

21. The prediction system according to claim 18, further comprising a prediction device which predicts the characteristics of a communication device, wherein:
the vicinal node information acquisition unit acquires edge information of a prediction target communication device;
the feature value calculation unit calculates a feature value of the prediction target communication device by using the edge information and feature information of the other communication device; and
the prediction device predicts the characteristics of the prediction target communication device by using the model learned by the learning device and the feature value of the prediction target communication device.

22. The prediction system according to claim 18, wherein the vicinal node information acquisition unit acquires feature information of the other communication device from the edge information.

23. The prediction system according to claim 22, wherein the vicinal node information acquisition unit acquires information indicating time variation of the other communication device as feature information.

24. A prediction method for predicting characteristics of a user, on which attention is focused, among a plurality of users communicating to each other, the prediction method comprising:
accepting an input of feature information associated with the users and an input of communication history information indicating a communication history between the users;
identifying users who are a communication opposite party of a user based on the communication history information;
generating a feature on the basis of a feature information associated with the identified users; and
generating a model for predicting the characteristics of the user, on which attention is focused, by using the generated feature.

25. A prediction method for predicting characteristics of a communication device, on which attention is focused, among a plurality of communication devices communicating to each other, the prediction system comprising:
accepting an input of feature information associated with the communication devices and an input of communication history information indicating a communication history between the communication devices;
identifying communication devices which are a communication opposite party of a communication device based on the communication history information;
generating a feature on the basis of a feature information associated with the identified communication devices; and
generating a model for predicting the characteristics of the communication device, on which attention is focused, by using the generated feature.

26. A non-transitory computer readable information recording medium storing a prediction program applied to a computer which predicts characteristics of a user, on which attention is focused, among a plurality of users communicating to each other, when executed by a processor, the prediction program performs a method for:
accepting an input of feature information associated with the users and an input of communication history information indicating a communication history between the users;
identifying users who are a communication opposite party of a user based on the communication history information;
generating a feature on the basis of a feature information associated with the identified users; and
generating a model for predicting the characteristics of the user, on which attention is focused, by using the generated feature.

27. A non-transitory computer readable information recording medium storing a prediction program applied to a computer which predicts characteristics of a communication device, on which attention is focused, among a plurality of communication devices communicating to each other, when executed by a processor, the prediction program performs a method for:
accepting an input of feature information associated with the communication devices and an input of communication history information indicating a communication history between the communication devices;
identifying communication devices which are a communication opposite party of a communication device based on the communication history information;
generating a feature on the basis of a feature information associated with the identified communication devices; and
generating a model for predicting the characteristics of the communication device, on which attention is focused, by using the generated feature.

28. A prediction system comprising:
a vicinal node information acquisition unit that acquires edge information that indicates a connection relationship between one node and another node to which the one node connects, from learning data that expresses inter-node connection relationships that are expressed as a graph structure or a network structure; and
a feature value calculation unit that calculates a feature value that is for the one node and that is to be used for prediction by using the acquired edge information and node feature information that indicates the features of the other node.

29. A prediction method comprising:
acquiring edge information that indicates a connection relationship between one node and another node to which the one node connects, from learning data that expresses inter-node connection relationships that are expressed as a graph structure or a network structure; and
calculating a feature value that is for the one node and that is to be used for prediction by using the acquired edge information and node feature information that indicates the features of the other node.

30. A non-transitory computer readable information recording medium storing a prediction program, when executed by a processor, that performs a method for:
acquiring edge information that indicates a connection relationship between one node and another node to which the one node connects, from learning data that expresses inter-node connection relationships that are expressed as a graph structure or a network structure; and
calculating a feature value that is for the one node and that is to be used for prediction by using the acquired edge information and node feature information that indicates the features of the other node.
